(19) United States
(12) Patent Application Publication
(10) Pub. No.: US 2005/0095056 A1
(43) Pub. Date: May 5, 2005

(54) Scrub 'N' bag

(76) Inventor: Elaine King, Myrtle Beach, SC (US)

Correspondence Address: ELAINE KING, 455 SUNNEHANNA DR. #413, MYRTLE BEACH, SC, 29588, US

(21) Appl. No.: 10/972,731

(22) Filed: Oct. 25, 2004

Related U.S. Application Data
(60) Provisional application No. 60/517,066, filed on Nov. 5, 2003.

(51) Int. Cl. B43K 8/10

(52) U.S. Cl. 401/201

(57) ABSTRACT

The SCRUB'N'BAG is a personal bathing accessory which is composed of polyester mesh material. There is a cord channel around the top opening of the bag through which a nylon cord is threaded. Once the soap bar is placed in the bag, the cord is drawn to close the top of the bag. The excess nylon cord can be placed around the wrist and the vinyl slide is used to comfortably secure the bag to the wrist, eliminating the need to ever have to retrieve a dropped bar of soap again. The material at the top half of the bag can be used instead of a washcloth, or the bather may hold the lower half of the bag, which contains the bar of soap, and wash the body. The mesh polyester material allows the soap suds to pass through while also providing gentle exfoliation of skin.

### CROSS REFERENCE TO RELATED APPLICATIONS

| | | | |
|---|---|---|---|
| 6267524 | July, 2001 | Kroha | 401/7 |
| 5895163 | April, 1999 | Chapman | 401/201 |
| 5787542 | August, 1998 | Chien | 15/244.3 |
| 5715561 | February, 1998 | Tuthill | 15/229.11 |
| 4457640 | July, 1984 | Anderson | 401/7 |

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISK APPENDIX

Not applicable

### BACKGROUND OF THE INVENTION

This non-provisional utility patent application claims the benefit of the filing date of provisional patent application No. 60/517,066 filed on Nov. 5, 2003.

Although a bar of soap is a necessity to most and even a luxury to some, since it's creation, there have always been problems associated with it's use. The SCRUB'N'BAG is a soap bag that was invented out of necessity to deal with and eliminate most of those problems.

A very common problem that is encountered while bathing with a bar of soap is when it slips out of the bather's hand. What may be a simple annoyance in a tub bath can become a major problem for some users when they are bathing in a shower. There is the potential for an accidental fall and injury if the user steps on the dropped bar of soap. Also, retrieving a slippery bar of soap, which has been dropped in a shower, can become a painful or exhausting ordeal for anyone who may be physically disabled, elderly, blind, pregnant or overweight.

Another problem is the sanitary issue of a dropped bar of soap. When a wet bar of soap hits the shower floor, it has a tendency to collect whatever it comes into contact with, such as hair, germs and dirt.

It is also difficult for someone to travel with their own personal bar of soap because when using bathing facilities at places such as hotels, motels and campgrounds, they may be reluctant to retrieve a dropped bar of soap or hesitant to put their personal bar of soap on a place provided in the bathing area. Even the cleanest bathing areas can harbor germs and diseases which may be passed unknowingly from one traveler to another on a bar of soap.

A more noticeable problem when using bar soap is that soap dishes tend to collect water which results in a mushy, messy soft bar of soap that dissolves too quickly and breaks, resulting in loss of soap and the money spent for the soap.

Another problem is that although a bar of soap may produce lather, it alone does not have the ability to efficiently scrub dirt from the skin or exfoliate dead skin. A bar of soap can not clean adequately in small places such as behind the ears or between the toes.

There are a variety of soap bags on the market but they are complicated to use or contain a bulky or dense material that tends to retain soap and moisture. A material that does not dry quickly can promote the growth of mildew and harbor disease causing micro-organisms.

### BRIEF SUMMARY OF THE INVENTION

The SCRUB'N'BAG was invented due to the necessity of a convenient, safe, sanitary, efficient, more economical and simpler way for an individual to enjoy the use of their own personal bar of soap while bathing.

The SCRUB'N'BAG is a bag that is large enough to hold a full size bar of soap and some small or broken pieces of soap and still have enough loose material to use as a wash cloth. The SCRUB'N'BAG has a cord channel on the open end of the bag and a soft but durable nylon cord is drawn to close the bag after the soap is placed in the bag. Once the cord is drawn to close the bag, the remaining exposed cord (the two loose ends are knotted together) is then slipped over the wrist and the short piece of vinyl tubing is slid toward the wrist just far enough to secure the bag to the wrist during the bathing process. The nylon cord eliminates all problems associated with dropping the soap. If the user drops the bag, it is still close at hand as it hangs from the wrist by the cord.

With the SCRUB'N'BAG, the bar of soap and the bag itself never needs to come in contact with anything other than the user's body. At home or traveling, during use, the SCRUB'N'BAG can remain in the user's hand (with cord secured to wrist) or simply hang from the user's wrist. Between uses, the SCRUB'N'BAG can be hung by the cord to air dry. When camping in the “great out doors” the SCRUB'N'BAG can be hung on a convenient branch to dry. When traveling, the SCRUB'N'BAG can be placed in a plastic zip-loc bag for convenience and hung to dry at the next destination. The ability to air dry the soap bar eliminates mushy, soft soap and extends the life of a bar of soap.

The body of the SCRUB'N'BAG is composed of 1/16 inch mesh polyester material. The 1/16 inch holes in the mesh are large enough to allow for easy lathering of soap, faster drying after use, and visual contact with the contents of the bag. The 1/16 inch holes are small enough to deter body hair from clinging to the soap. The material at the top half of the bag can be used as a wash cloth and is capable of reaching areas such as behind the ears and between the toes. The mesh material feels soft to the touch but is sturdy enough to gently exfoliate and clean the user's skin.

### BRIEF DESCRIPTION OF THE SEVERAL VIEWS OF THE DRAWINGS

FIG. 1 is looking down on the inner surface of the 10 inch×12 inch piece of polyester material that is to become the SCRUB'N'BAG and shows how the two adjacent corners are folded that will become the beginning and end of the cord channel.

FIG. 2 is looking at the edge of the material as it shows the folding process of the cord channel.

FIG. 3 is looking down on the outside surface of the material to show the position of the cord channel as the seam that forms it is sewn.

FIG. 4 is looking down on the outside surface of the material to show the position of the cord channel after it was sewn and then unfolded away from the body area of the bag.

FIG. 5 is showing the inside surface of the material after it has been folded in half (inside-out) and the seams were sewn to form the SCRUB'N'BAG.

FIG. 6 is showing the completed SCRUB'N'BAG, right side out, lying on a flat surface, with the nylon cord and vinyl slide in place.

### DETAILED DESCRIPTION OF THE INVENTION:

The SCRUB'N'BAG is composed of a bag which is made from a 10 inch×12 inch rectangle of 1/16 inch mesh polyester material, approximately 23 inches of soft nylon cord and a short section of clear, flexible vinyl tubing which is used as a slide on the cord.

The unique aspects of the SCRUB'N'BAG is it's simplicity of design and materials and, in spite of that simplicity, it provides a bather with the most useful bathing accessory since the invention of the wash cloth.

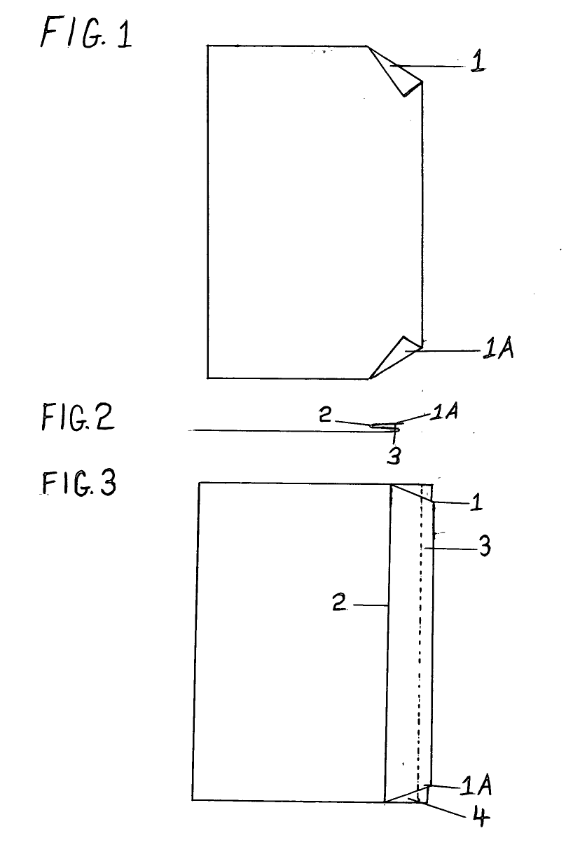

As illustrated in FIG. 1, construction of the SCRUB'N'BAG begins with a 10 inch×12 inch piece of 1/16 inch mesh polyester material by folding and sewing into place approximately one inch of the two adjacent corners, on one of the 12 inch edges, to approximately a 45 degree angle (1,1A). This edge with the folded corners will be the top portion of the SCRUB'N'BAG.

The next step in the construction requires the formation of the cord channel. As illustrated in FIG. 2 and FIG. 3, there are two accordian type folds, each approximately one inch×12 inches. The top edge of the material is folded (2) in towards the folded corners (1,1A) and then the top folded edge is folded back in the opposite direction, temporarily forming three layers of material which when sewn (3) will provide the cord channel and a hidden seam for the outside of the finished bag.

As illustrated in FIG. 3, there will be one long continuous 12 inch seam which is approximately ½ inch in from the raw edge and approximately ¼ inch in from the underlying folded edge. This seam secures the cord channel.

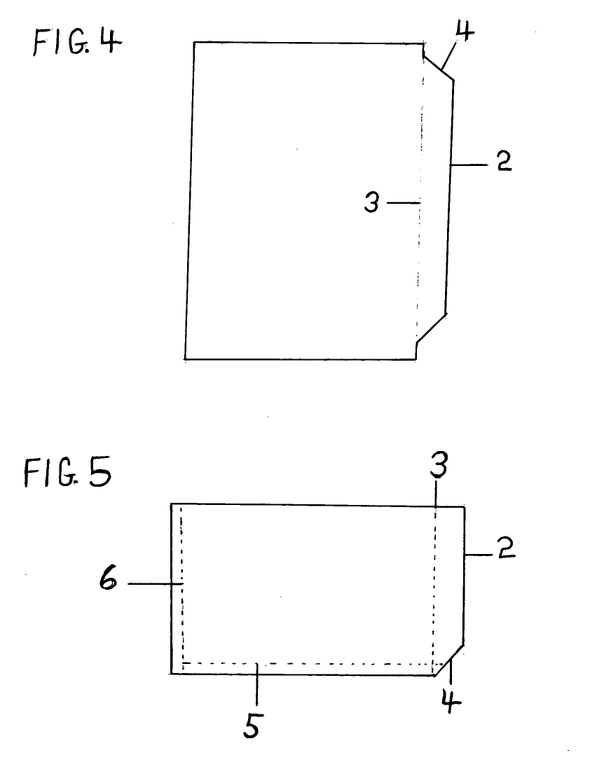

As illustrated in FIG. 4, the second fold is now unfolded so the top (2) edge of the completed cord channel (4) is now fully extended. The cord channel is completed and the seam at the bottom of the cord channel (3) will not show any visible thread on the outside of the bag. The next step involves forming the actual bag. As illustrated in FIG. 5, the material is folded in half, inside out, with the opposing ends of the cord channel brought together. Then starting approximately 1 inch from the top of the cord channel, sew a ½ inch seam down the side (5) and across the bottom (6) to complete forming the bag.

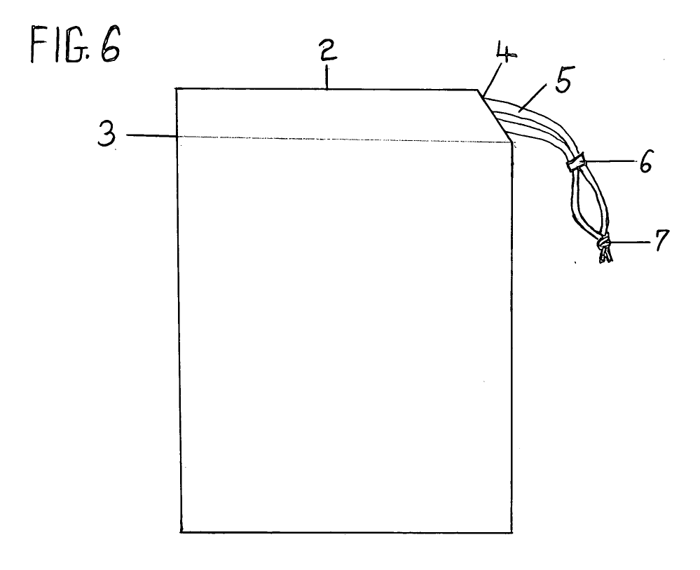

FIG. 6 illustrates the completed SCRUB'N'BAG, right side out, with the nylon draw cord (6) and the vinyl tubing (7) in place. FIG. 6 also shows the knot (7) near the end of the now doubled draw cord. The distance between the knot (7) and the vinyl tubing slide (6) will form a loop when the cords are separated and the loop will slip over the wrist and the vinyl slide will be moved towards the wrist to gently secure the bag to the wrist. If the SCRUB'N'BAG, containing the bar of soap, drops out of the user's hand it remains handily attached at the wrist. Use of the SCRUB'N'BAG is more simple and easier than using the conventional bar of soap and wash cloth for bathing.

The polyester mesh material of the SCRUB'N'BAG eliminates the problem of trying to grasp a slippery bar of soap. The 1/16 inch holes in the mesh material are large enough to allow easy lathering, a view of the contents, and faster drying than a solid material. The 1/16 inch holes in the mesh material are small enough to deter hair or other objects from sticking to the soap.

Use of the SCRUB'N'BAG for bathing simply involves placing a bar of soap into the bag, pulling the soft nylon draw cord to close the top of the bag, looping the other end of the draw cord over the wrist and sliding the short section of clear flexible vinyl tubing toward the wrist. The bag is now ready to use. Just wet the bag and rub it between hands to generate lather then rub bag over wet body for cleansing and gentle exfoliation.

Problems with other existing soap bags include multiple panels which make the product more complicated and add to the expense of materials and labor. Multiple layers also lengthen the drying time of a soap bag which can degrade the durability of the materials and also allow growth of mildew and germs.

Some bags are composed of plastic materials which do not have the ability to exfoliate the skin surface as efficiently as a polyester mesh material. A plastic material has a tendancy to feel slippery when wet and lathered.

Bags that rely on pads or sponges lack the ability to dry completely in a timely manner and they occupy more space which is especially inconvenient when traveling.

1. The SCRUB'N'BAG is the ultimate self cleansing personal bathing accessory when washing oneself with a bar of soap, comprising:
A bag composed of mesh material having an open end through which bar soap is added.
A cord threaded through a cord channel on the open end of the bag.
A device for the purpose of securing the cord and bag to the wrist while in use.
The weight of the soap maintains the closure of the bag, during bathing, once the cord is drawn.

2. The SCRUB'N'BAG, according to claim 1, wherein said bag is manufactured from a 10×12 inch rectangle of 1/16 inch mesh, polyester material.

3. The SCRUB'N'BAG, according to claim 1, wherein said bag has a cord channel around the open end and said channel includes approximately 23 inches of a soft nylon draw cord of which the two loose ends are knotted together.

4. The SCRUB'N'BAG, according to claim 1, wherein the securing device on said cord is comprised of a short section of clear, flexible vinyl tubing which is able to to slide along the double section of the draw cord to adjust the loop size to fit the users wrist.
